(19) United States
(12) Patent Application Publication
(10) Pub. No.: US 2002/0169221 A1
(43) Pub. Date: Nov. 14, 2002

(54) Process of making a modifier for cement systems

(76) Inventor: Jaime Moreno, Chicago, IL (US)

Correspondence Address: Palmatier & Zummer, Suite 1222, 39 South LaSalle Street, Chicago, IL, 60603, US

(21) Appl. No.: 10/078,560

(22) Filed: Feb. 18, 2002

Related U.S. Application Data
(60) Provisional application No. 60/269,512, filed on Feb. 16, 2001.

(51) Int. Cl. C09G 1/00

(52) U.S. Cl. 520/1; 525/53; 525/154

(57) ABSTRACT

The disclosed process to obtain a modifier for cement systems comprises a synthesis of the modifier by a process of polymerization in a soft alkaline catalysis. This contributes to the formation of a product with a low molecular mass and viscosity. The concentration of the homogeneous aqueous solution is from 40-58% and the specific production of the process is Q=0.25 to 3.00 kg per hour in comparison with the specific production of the known prototype which is Q=0.03 to 0.04 kg per hour. One of the most important characteristics of the new process used to obtain the disclosed modifier is the fact that synthesis is achieved without external heat sources. Also, synthesis is achieved either by a periodic process or a continuous process. Another important characteristic of this process is the possibility to optimally combine a synergist in the form of a copolymer of formaldehyde with polycondensed desulfitade and the product of the aldonic condensation of the homopolymer in the presence of an alkaline starter. As a result, the required distribution of the molecular mass (DMM) is obtained and the temperature of the reactive mass is regulated during the final phase of the synthesis. The reactive mass temperature in the final phase is from 50-70° C.; the pH of the final product is auto-regulated without using special neutralizers, showing a value of 7.1-8.8 at a temperature of 20 +/− 2° C., and the average of the molecular mass will not exceed 340 Dalton. The unique properties of the final product insures the efficiency of the cement system modifiers with relatively low molecular mass. Synthesis occurs in a short period of time due to the combination of the high reactive capacity of the monomer, the high velocity of the elemental reactions and the growth of the polymeric chain. The absence of secondary products during the polymerization process results in a specific production of Q=0.25-3.0 kg per hour, which is one or two orders higher when compared with known technologies. In spite of the relatively low molecular mass, the disclosed modifier is distinguished by a high plasticizing effect and a reduction in water consumption in cement systems. The modifier is recommended for use in the clinker mill in order to substantially increase all the technical properties of cement and/or to increase the production of the mill of up to 45%, retaining the normal properties of the cement. The modifier can also be utilized for the production of relatively dry and self-leveling mortar and concrete mixes. In addition, the modifier can be used as a superplasticizer in cement systems. In addition, the modifier is a compactor of the microstructure, simultaneously increasing the strength of cement systems at all hardening ages and maintaining the value of the W/C ratio. If self-leveling mixes are used, the increase in strength of the components utilizing cement modified with the disclosed modifier can be increased up to 80%. From the above-mentioned properties, the conclusion is evident that the disclosed modifier represents a new technical solution related to the technology of its production and related to improved properties in cement systems.

### FIELD OF THE INVENTION

The invention disclosed herein relates to the manufacture of organic polymer substances soluble in water and used in the construction materials industry as modifiers of the properties of cement systems. Such modifiers are used in the fabrication of cement and concrete and/or in other construction materials using as a starting point portland cement and its varieties.

### OBJECTIVES OF THE INVENTION

The main objective of the invention is to improve the dispersion of portland cement during the process of grinding the portland cement clinker with different types of calcium sulfate and/or clinker with calcium sulfate and active mineral additives. The invention is also used to increase the quality of cement and/or to improve the efficiency and productivity of the grinding mill. The invention is also used to increase the workability of mortar and concrete mixtures with regard to self-leveling without exterior intervention. Another purpose of these modifiers is to increase density and strength at all ages during hardening of cement systems.

### SUMMARY OF THE INVENTION

As a general rule, modifiers use polymers based on aromatic sulfoacids. They are obtained by means of copolycondensation of corresponding monomers with formaldehyde. This process of polycondensation is endothermic, which requires a permanent supply of exterior heat. The polycondensation of sulfoacids is known for a constant decrease in reaction speed resulting in a prolongation of the manufacturing process. This requires a great contribution of energy and contributes to a low specific production [Q]; Q=production volume (as a dehydrated product) per unit of time.

The effectiveness of the above-mentioned modifiers in cement systems is determined by their molecular mass (MM) [1]. Products with low MM have a weak plasticizing effect and low water reduction efficiency. Therefore, a high level of polycondensation of sulfoacid is necessary to assure increased efficiency of the modifier in cement systems. Solutions of these compounds have high viscosity, which hampers efficient displacement into large volume reactors. The danger of local overheating exists and the process of molecular diffusion is highly retarded in the reagents' molecules and in intermediate substances. As a result, it becomes difficult to obtain the conversion [α] of the starting monomers.

In order to overcome the above-mentioned technical difficulties, diluted reactive masses are used. In addition, water is accumulated as a secondary product in the process of polycondensation. This reduces the specific production of the process [Q] even more, which diminishes the concentration of the final product.

Another problem with the process for obtaining these modifiers is that it requires the use of special complementary reagents to regulate the average pH. This makes the technological plan and manufacturing process more complex.

The modifier based on melamine with formaldehyde (SMF) [2] has an elevated plasticizing effect and reduces the use of water without diminishing the strength of cement systems with the same water/cement ratio. However, these properties are present only in samples with high molecular mass (MM from 17,000 to 30,000 Dalton) [3, 4] and high viscosity. Also, during the synthesis of the polymer, 18.5% water is produced in proportion to the mass of the starting monomer. As a result, the final product is an aqueous solution of up to 20%, with a specific production of approximately Q≈0.07 to 0.08 kg per hour. Also, melamine modifiers and formaldehyde have a tendency for spontaneous polymerization, which drastically decreases their efficiency in cement systems.

The closest prior art or prototype to the present innovation is a modifier resulting from the co-polymerization of sulfoacid of naphthalene with formaldehyde (SNF) [5]. This copolymer has a high plasticizing effect and decreases water consumption in cement systems. The efficiency of these copolymers in cement systems is obtained with a considerably lower value of molecular mass (MM=2,000 to 3,000 Dalton), and water resulting during the synthesis is about 7.5% in proportion to the monomer mass. This results in an increased modifier concentration of 36-42%. However, the synthesis of the above-mentioned copolymer is characterized by the requirement of an elevated amount of energy. For example, the maximum temperature may be 165° for a lengthy period, and a manufacturing cycle may take about 20 to 30 hours. As a result, the specific production does not reach the value of Q=0.04 kg per hour.

The present innovation is a process with high production and low energy consumption used to obtain a modifier with a high plasticizing effect (i.e. self-leveling) and a considerable reduction of water in cement systems (mortar, mortar with sand and concrete). The invention does not retard the kinetics of the hardening process of cement systems; and it increases the dispersion of cement during the process of grinding clinker with different types of calcium sulfate and mineral additives (usually active) in a continuous process which increases the production of the grinding mill. Cement quality is maintained, resulting in high quality mortars and self-leveling concretes with low water consumption. Strength increases during all ages of cement hardening.

In the above-mentioned process the synthesis of the modifier is obtained by means of its polymerization in a soft alkaline catalysis (pH<12.5), which contributes to the formation of products with low molecular mass and low viscosity. To initiate the growth of the chain and maintain the reactive mass temperature during the polymerization process, the exothermic effect is utilized during the beginning of the starting monomer cycle. A calculated quantity of copolymer of formaldehyde, polycondensed desulfitade is introduced to increase the plasticizing effect, reduce water consumption and also to regulate the molecular mass and the temperature of the homopolymer during the final phase of the synthesis. This process takes place at a temperature of 55-70° C. in the reactive mass. The specific production of the process reaches a magnitude of Q=0.25-3.0 kg per hour.

To obtain the above-mentioned modifier, an aqueous solution of dioxilate of methylene calcium is used as a monomer, or preferably, the afore-mentioned monomer solution in a solvent comprising water and an aliphatic aldehyde or the mixture of various aliphatic aldehydes and/or ketones are used in the following mass proportions:

Water 100

Addition of aliphatic aldehydes and/or ketones 1.0-110

The modifier can be obtained by means of a periodic process in a reactor equipped with an internal lining or jacket to provide water for refrigeration, a thermometer to measure the temperature, a mixer and a pH indicator. The temperature margin of this process is 42-80° C.

As the process is approaching 100% of the monomer conversion, an optimum quantity of a synergist, copolymer of formaldehyde with polycondensed desulfitade, is added. The temperature in the reactor is regulated spontaneously, remaining at a level of 60-65° C. while the distribution of the molecular mass in the modifier stabilizes. The specific production is Q=0.25-3.0 kg per hour.

The modifier is produced in a continuous process by means of a continuous supply of the monomer and the initiating system in three cascading reactors. Each reactor has the same volume, each has a jacket for the supply of water for refrigeration, a mixer, and a pH indicator. The mass is moved in a continuous flow from one reactor to another by gravity until the final product exits the reactors. The copolymer of formaldehyde with polycondensed desulfitade is supplied in an optimum calculated amount by means of a liquid dose measurer. This liquid copolymer is introduced by gravity into the cascading system's last reactor where the mass temperature is 55-70° C. and the homopolymer conversion (α) is 100%. In this system, the first reactor is the homogenizer and initiator of the polymerization process. The following are the technological regimes in the three contiguous, cascading reactors:

| Reactor No. 1 | Reactor No. 2 | Reactor No. 3 |
|---|---|---|
| α, % up to 20 | between 90-98 | 100 |
| T, ° C. between 32-48 | 52-78 | 50-70 |
| pH 9.0-11.5 | 8.2-9.7 | 7.8-8.8 |

The specific production is Q=2.5-3.0 kg per hour.

The continuous process for producing the modifier can be accomplished by administering the monomer and the initiating system in an optimum proportion at a regulated velocity and at a temperature no higher than 35° C. in the first reactor of the series, as has been previously described. Once the monomer is 100 % converted in the last reactor, a calculated quantity of copolymer of formaldehyde with polycondensed desulfitade is introduced as previously described. In this case, the following are the technological regimens.

| Reactor No. 1 | Reactor No. 2 | Reactor No. 3 |
|---|---|---|
| α, % up to 30 | up to 98 | 100 |
| T, ° C. between 45-55 | 52-70 | 50-58 |
| pH 8.8-10.5 | 8.2-8.8 | 7.8-8.3 |

The specific production is also Q=2.5-3.0 kg per hour.

The modifier's continuous production process can be achieved in a system with two continuous reactors. Each of the reactors has a jacket to provide water for refrigeration, a mixer, a thermometer and a pH indicator. The passage of the mass from one reactor to another reactor and the exit of the final product are accomplished by gravity. In this case when the monomer conversion reaches 100%, the optimum quantity of copolymer of formaldehyde with polycondensed desulfitade is introduced into the second reactor in the same way as in the previous process. The following are the technological regimens for a system with two cascading reactors:

| Reactor No. 1 | Reactor No. 3 |
|---|---|
| α, % up to 60 | 100 |
| T, ° C. 43-60 | 52-70 |
| pH 8.7-10.2 | 7.1-8.5 |

An aqueous suspension of one or various hydroxides, alkaline earth metals or a mixture of equivalent oxides in water is used as an alkaline initiator of polymerization.

A mixture of hydroxides of alkaline earth metals with one or various common salts with the formula M(NOₓ)_{y}, where x=2 or 3 and y=1 or 2, may also be used as an alkaline initiator of polymerization.

The polymerization process develops in such a way that when the monomer is 100% converted and the optimum quantity of copolymer of formaldehyde with. polycondensed desulfitade is introduced, the manufactured product's molecular mass is distributed in the last phase of the synthesis (in both periodic and the continuous preparation of the modifier) as follows:

light fraction with a molecular mass (MM) less than 120 Dalton—not more than 20 parts of mass;

medium fraction with MM of 150±50 Dalton—not more than 40 parts of mass;

heavy fraction with MM of 180 and more (the remaining parts of mass)—the viscosity at 20° C. should not exceed 2·10⁻³ N·C/m²

The disclosed technical solution's basic concept for the cement system modifier's manufacturing process is that it is produced with the energy resulting from the interaction of the heterocyclic monomer and the initiating system, without using external heat sources; at the same time the intermediate product initiates the polymerizing process, which is characterized by the reaction's constant, high velocity and by the absence of secondary products; the reactive mass's composition is mixed in such a way that at the moment of the monomer's 100% conversion and introduction of the copolymer of formaldehyde with polycondensed desulfitade, the average pH is reduced to 7.1-8.8. The innovations of this technical solution are as follows:

specific production of 0.25-3.0 kg per hour, which is one or two orders higher than the production of known modifiers;

process produces the modifier without external sources of heat;

modifier may be manufactured by means of a periodic process or by a continuous process;

use of dioxilate of methylcalcium as a reactive heterocyclic monomer;

use of a polymerization process to obtain the modifier for cement systems;

use of a copolymer of formaldehyde with polycondensed desulfitade in combination with an alkaline initiator as a synergist for the required distribution of the molecular mass (DMM) and control of the reactive mass's temperature during the final phase of synthesis of the modifier;

auto-regulation of the pH without the use of neutralizing minerals in the manufacturing process, thus obtaining a pH value between 7.1 and 8.8 in the final product.

A very high specific production is obtained by this process due to the use of a small heterocycle as a monomer. The result is a high reactive capacity in the compound with the optimum composition of the initiating system. This allows the synthesis of the modifier by the polymerizing process.

Since water is not obtained as a secondary product in the polymerizing process, the non-desirable solution of the reactive mass is avoided; therefore, a high velocity of the reaction is maintained. As a result, the final product is a concentrated solution ©=40-58%).

The unique properties of the final product assure a high efficiency as a modifier in cement systems with relatively low molecular mass, which permits its synthesis in a short period of time.

The production of Type SMF modifier requires 2 to 2.5 hours and Type SNF modifier requires 10 to 30 hours. The synthesis of the disclosed modifier requires 10 to 45 minutes.

The combination of the elevated reactive capacity of the monomer, the high velocity of the basic reactions relative to the growth of the polymeric chain and the low molecular mass of the product, with no formation of secondary products during the polymerization process result in a specific production of 0.25 to 3.0 kg per hour, which is from one to two orders greater than known technologies.

The synthesis of known modifiers by the polymerization mechanism requires an external heat source to surpass the energy barrier and the formation of a methyl hydroxide monomer, which is the initiator of the final chain growth. The exothermic effect of the subsequent phases of the process is not able to compensate for the endothermic effect of the first phase, consequently the synthesis process of the above-mentioned modifiers requires a permanent heating of the reactive mass. Considering the high temperatures of this synthesis (85-90° C. for SMF and 105 to 165° C. for SNF) and the extended duration of the process, this process for the manufacture of modifiers is too demanding with respect to energy.

In the disclosed technical solution, the energy required for the start of the heterocycle is so insignificant that the heat released during the ensuing polymerization not only compensates for the endothermic effect of the first phase of the synthesis, but also causes a spontaneous heating of the reactive mass to appropriate temperatures necessary for the completion of the process without external sources of heat.

The low molecular mass of the modifier obtained by means of the disclosed technical solution predetermines the unique characteristics of the intermediate reactive masses with respect to the technology of chemical processes. Low viscosity, the absence of the concentration gradient (as a consequence of the absence of diffusion limitations) and the absence of local overheating result in a complete homogeneity of the reactive mass and easy displacement from one reactor to the other. This, for the first time, permits the synthesis of the modifier for cement systems to be achieved not only by means of the periodic process but also by means of the continuous process, which is superior from a technological point of view.

Monomers usually used for obtaining modifiers for cement systems are aromatic carbocyclic compositions of: naphtahalene, methylnaphthalene, esterine, phenol, anthracine, phenathrene and others. The heterocyclic monomer, melamine, is used in only one case. However, in the synthesis of formaldehyde and melamine modifiers, the growth of the chain occurs due to the polycondensation mechanism, maintaining the integrity of the cycle and forming bridge unions between the aromatic rings.

In the disclosed solution, the reactive heterocyclic monomer is used which opens easily in the presence of OH⁻ ions, thus initiating the growth of the polymerizing chain.

Acid compounds (mineral acids or Lewis acids) may also be used as initiators of the polymerization reaction. However, in this case, the growth of the chain occurs uncontrollably and the polymer formed is characterized by a high molecular mass. Modifiers based on polymers of this type have a high plasticizing effect and reduce water consumption in cement systems, but they retard the initial phases of hydration, microstructure formation and hardening of the cement systems.

If they are used as initiators, polymerization ends in the formation phase of oligomer-type compounds, since for the oligomeric anion, stabilization by transmission of the proton is more advantageous than by continuation of the chain by means of the nuclear mechanism. Furthermore, although with the initiation of each new chain, reactive alkaline is reduced, it is possible (establishing the optimum proportions of the components of the reactive mass) to not only regulate the DMM of the final product but also to auto-regulate the pH.

To achieve the synthesis of the polymer (polymeric type or based on polycondensation) the regulation of the final product's pH is possible only by introducing a calculated amount of an additional alkaline reagent in the presence of an acid initiator.

In spite of its low molecular mass, the disclosed modifier of cement systems is distinguished by a high plasticizing effect and a marked reduction in water consumption. Furthermore, as the modifier compacts the microstructure, it increases the strength of cement systems with the same water/cement value at all ages of the hardening process.

The characteristics of the disclosed innovation will be clearer by studying the following examples of its manufacture.

### EXAMPLE 1

The synthesis of the modifier of the disclosed cement systems was achieved by mixing together a calculated amount of an aqueous monomer solution and the system initiator having a pH of 12.5. Two minutes after the homogenization of the reagents (achieved by uninterrupted mechanical agitation), the pH value of the reactive mass was 11.6 and the temperature, a result of the exothermic process of the monomer with the initiator, was 38° C.

To regulate polymerization, synthesis is accomplished by cooling the reactive mass in thermostatic conditions to a temperature of 60-65° C. After 35 minutes the monomer's conversion is 100%. At that moment, a pre-mixed, optimum, calculated amount of copolymer of formaldehyde with polycondensed desufitade is introduced into the reactor to stabilize the temperature and distribution of the molecular mass (DMM) in order to intensify (synergize) the plasticizing and water reduction effects on the final product. At that time, the temperature is spontaneously stabilized at 55-60° C. and the absence of free monomer signals the completion of the synthesis process. The molecular mass of the modifier obtained is distributed in the following manner: light fraction with a molecular mass less than 12 Dalton and no more than 20 parts of mass; medium fraction with a molecular mass of 150±50 Dalton and no more than 40 parts of mass; heavy fraction with a molecular mass of 180 Dalton and the remaining parts of mass. The viscosity at 20° C. is not higher than 2×10⁻³N×C/m². The specific production of the process was 1.8 kg per hour.

The manufactured product has a pH=8.1 and a concentration of 45%.

The comparison of the basic parameters of the modifier's synthesis for cement systems is shown in Table 1.

TABLE 1

| | Synthesis | | | Monomer |
|---|---|---|---|---|
| Modifier | Temperature | Synthesis | Productivity, | Conversion |
| Type | T, ° C. | Duration | Q, kg per hour | Amount, % |
| Obtained by | 60-65 | 37 min. | 1.8 | 100 |
| the | | | | |
| Disclosed | | | | |
| Process | | | | |
| Prototype | 105-165 | 31-35 hrs. | 0.034 | 90-94 |

As can be seen in Table 1, the disclosed process for the manufacture of the modifier for cement systems is better in all the parameters than the referenced process.

The synthesis of the disclosed modifier takes place at a moderate temperature and differs from the referenced process in that only the thermal energy of the polymerization of the monomer is used. The specific production of the disclosed process is increased more than 50 times.

The comparison of properties of cement systems with modifiers obtained by the disclosed process and those of the prototype modifier is shown in Tables 2 and 3.

TABLE 2

| | | | Cement Paste | | |
|---|---|---|---|---|---|
| | Cement | | Characteristics | | |
| | Grinding | | Water | | |
| | Time | Blaine* | Paste | Hardening Time | |
| Modifier Type | (min.) | cm²/gr. | Normal, % | Initial | Final |
| — | 90 | 4,200 | 26.4 | 2 h 45 | 4 h 30 |
| | | | | min | min |
| Obtained by | 90 | 5,260 | 19.8 | 2 h 15 | 3 h 45 |
| Disclosed | | | | min | min |
| Process | | | | | |
| Prototype | 90 | 4,450 | 19.0 | 1 h 15 | 4 h 10 |
| | | | | min | min |

*Preparation of the cement took place in a laboratory mill, grinding together clinker (95%), calcium sulfate (5%) and modifiers (each 0.95% in dry form). Clinker composition was: C₃S = 64-68%; C₂S = 7-10%; C₃A = 6-9%; C₄AF = 10-12%; K₂O = 0.85% and Na₂O = 0.6%.

From the information in Table 2 it is evident that a greater Blaine dispersion is procured with the use of the modifier obtained by the disclosed process in cement preparation; the quantity of water necessary to obtain a paste of normal consistency is practically the same as in the case of the prototype modifier; the hardening of the paste conforms to UNE 80 301:96 (or ASTM C 595) standards.

TABLE 3

| | | Slump, | | | |
|---|---|---|---|---|---|
| | | Standard | | | |
| Modifier | | Cone | Comprehensive Strength, N/mm² | | |
| Type | W/C | mm | 2 days | 7 days | 28 days |
| — | 0.62 | 65 | 17.5 | 25.4 | 29.3 |
| Obtained by | 0.62 | 260 | 19.6 | 32.3 | 34.7 |
| Disclosed | 0.48 | 70 | 26.8 | 39.8 | 43.9 |
| Process | | | | | |
| Prototype | 0.62 | 254 | 16.6 | 24.8 | 28.3 |
| | 0.48 | 72 | 22.7 | 33.2 | 38.4 |

Observations:

The composition of the concrete mixture with a water to cement (W/C) ratio=0.62 is as follows: 300 kg/M³ Type II industrially manufactured cement—C/35 A (72% clinker+gypsum+28% fly ash); 810 kg/m³ sand (0-5 mm); 1040 kg/m³ coarse aggregate (6-25 mm); 186 kg/m³ water.

Concrete mixtures with W/C=0.48 are as follows: 300 kg/m³ Type II industrially manufactured cement—C/35 A; 869 kg/m³ sand (0-5 mm); 1087 kg/M³ coarse aggregate (6-25 mm); 144 kg/m³ water. In all the experiments, the modifier dose was 0.5% of the cement mass. Properties of the concrete samples were obtained from cylinders with a diameter of 15 cm and a height of 30 cm.

From Table 3 we can see that in reference to the plasticizing effect and the effect of water usage, modifiers obtained by the disclosed process and reference modifiers are identical. However, the compressive strength of cement samples with the modifier obtained by the disclosed manufacturing process is superior at all ages of the hardening process.

### EXAMPLE 2

Synthesis of the modifier for cement systems was achieved as in Example 1. The solution of dioxilate of methylene calcium in water or in a combined solvent, consisting of water and an aliphatic aldehyde or a mixture of various aliphatic aldehydes and/or ketones, was used as a monomer in the following mass proportions:

Water 100

Addition of aliphatic aldehydes and/or ketones 1.0-110.

The use of such aqueous organic solvents for the heterocyclic monomer facilitates polymerization, resulting in a more concentrated product.

If higher proportions surpassing quantity limits are used for the components of the combined solvent, the exothermic condition of polymerization surpasses the velocity of heat evacuation, and it becomes difficult to regulate the temperature of the reactive mass and the distribution of the molecular mass in the modifier. The result is a final product characterized by a relatively low effect with regard to plasticizing and water consumption (Table 4).

TABLE 4

| | Monomer Composition, Mass | | | | | |
|---|---|---|---|---|---|---|
| | Quantities | | | | | Mortar |
| | | | Aldehydes | | | Slump, |
| | Dioxilate of | | Aliphatic | Synthesis | Synthesis | Standard |
| Sample | Methylene | | and/or Ketones | Duration | Temperature | Cone |
| No. | calcium | Water | Summation | min. | ° C. | mm |
| 1 | 120 | 100 | 1.0 | 60 | 52 | 290 |
| 2 | 120 | 100 | 40.0 | 54 | 62 | >300 |
| 3 | 120 | 100 | 80.0 | 32 | 68 | >300 |
| 4 | 120 | 100 | 110.0 | 25 | 76 | 280 |
| 5 | 120 | 100 | 120.0 | 8 | 98 | 195 |
| 6 | 120 | 100 | — | 37 | 62 | 295 |
| 7 | 120 | — | — | — | — | 170 |

The results shown in Table 4 demonstrate that the use of the indicated proportions for the components of the combined solvent produces a modifier (Lines 1-4) with a plasticizing effect as per Example 1 (See Line 6 of Table 4 and Line 1 of Table 1).

The use of a higher quantity of aliphatic aldehydes and/or ketones (more than 100 parts of mass, Table 4, Line 5) makes heat evacuation more complex. As a consequence, the temperature of the reactive mass exceeds the permissible limit (more than 80° C.). As a result, the reaction occurs in a very short period of time, rendering the process useless under industrial conditions. Also, the modifier is characterized by a low plasticizing effect (Table 4, Line 5).

### EXAMPLE 3

The preparation of the modifier for cement systems was made as in Example 2. Synthesis was achieved by means of the periodic process in the reactor containing a jacket for refrigerated water, a mixer, a thermometer and a pH meter within a temperature range of 42 to 80° C.

After the monomer was 100% converted and the reactive mass was cooled to a temperature of 55-65° C., the optimum amount of the copolymer of formaldehyde with polycondensed desulfitade was introduced into the reactor.

The basic technological parameters of the synthesis and the properties of the standard cement and sand mortars with the modifiers obtained (modifier=0.6% of the cement mass) are shown in Table 5.

TABLE 5

| | | | | | Standard Mortar Properties | | | |
|---|---|---|---|---|---|---|---|---|
| | | | | | (Cement-Sand) | | | |
| | | | | | | Compressive | | |
| | Synthesis | Monomer | | Produc- | Slump | Strength | | |
| | Temper- | Conversion | Synthesis | tivity | Standard | N/mm² | | |
| Sample | ature | Amount | Duration | Q = kg per | Cone | | | 28 |
| No. | T, ° C. | a, % | min. | hour | mm | 2 days | 7 days | days |
| 1 | 38 ± 1 | 97 | 125 | 0.19 | 200 | 39.4 | 48.6 | 59.2 |
| 2 | 42 ± 1 | 98 | 70 | 0.75 | 208 | 41.7 | 47.9 | 60.1 |
| 3 | 54 ± 1 | 100 | 55 | 1.0 | 298 | 44.6 | 53.0 | 63.6 |
| 4 | 60 ± 1 | 100 | 38 | 1.4 | >300 | 43.8 | 52.4 | 64.0 |
| 5 | 75 ± 1 | 100 | 30 | 3.8 | >300 | 43.0 | 54.2 | 64.0 |
| 6 | 80 ± 1 | 100 | 20 | 3.0 | 297 | 45.4 | 53.7 | 62.8 |
| 7 | more than | 100 | 8 | 3.8 | 188 | 36.5 | 44.0 | 57.2 |
| | 82 | | | | | | | |
| 8 | Prototype | 92 | 1980 | 0.034 | 286 | 35.3 | 42.8 | 53.6 |
| | 165 | | | | | | | |
| 9 | Control | — | — | — | 170 | 37.6 | 46.3 | 55.8 |

Observations:

Cement Type I-O/45 A (Type1) without mineral additives was used to determine the plasticizing effect of the modifiers and their influence on the compressive strength of standard mortar samples (W/C=0.5=constant).

From the information in Table 5 it can be seen that if the modifier's synthesis process occurs at a temperature lower than 42° C., 100% monomer conversion is not achieved, even if the duration of the process is extended. As a consequence there is a low specific production (Table 5, Lines 2 and 3); if the synthesis occurs at a temperature higher than 82° C., the reaction becomes practically uncontrollable and there is also a relative reduction in the efficiency of the final product. If synthesis occurs in a temperature range of 54-80° C.±1° C., in all cases there is a monomer conversion of 100% and a high specific production of the synthesis.

The modifier synthesized within the regimens of the above-mentioned temperatures (54-80° C.±1° C.) results in mortars with higher compressive strength at all hardening ages as compared to prototype modifiers, with the same plasticizing effect.

### EXAMPLE 4

The modifier for cement systems was manufactured as in Example 2. Synthesis was achieved by means of the periodic process, supplying, continuously and separately, the monomer solution (a combined aqueous mineral solvent) and the aqueous solution of the initiating system (both in optimum proportions) in the system of three cascading reactors, each with the same volume. Each reactor was equipped with a jacket for water refrigeration, a mixer, a thermometer and a pH meter.

The transfer of the reactive mass from one reactor to another and the exit of the final product from the third reactor of the system is achieved by gravity through a device in the uppermost part of the reactors. In the disclosed technological process, the first reactor acts as homogenizer and initiator of the polymerization process. In the next two reactors, the gradual polymerization process of the monomer continues until 100% conversion takes place. In the last reactor, when 100% conversion of the monomer is completed and the reactive mass has been cooled to 55° C., the optimum quantity of copolymer of formaldehyde with polycondensed desulfitade is introduced into the last reactor in continuous, measured doses. The specific production of the process is assured to a margin of Q=2.5 to 3.0 kg per hour.

The technological parameters of the synthesis and test results with cement and sand mortars having the same consistency as the control are shown in Table 6.

From the results shown in Table 6 it can be seen that with the optimum parameters of the process (T=32-48° C. in the first reactor; 52-78° C. in the second reactor and 58-70° C. in the third reactor; pH=9.0-11.5; 8.2-9.7 and 7.8 to 8.8 respectively), the required monomer conversion takes place in each reactor (in Reactor 1, up to 20%; in Reactor 2, between 95-98% and in Reactor 3, 100%). Also, water use is reduced in cement systems utilizing this modifier. As a result, the compressive strength of the standard mortar samples is increased to 42% in two days and 76% in twenty-eight days (Table 6, Lines VII-IX) in comparison with the reference samples (Table 5, Line 9).

If the temperature is increased above the stated limit in any of the reactors of the system, it is impossible to maintain the pH of the reactive mass within the required limits. Also, it is not possible to obtain 100% conversion of the monomer during the passing of the mixture through the reactors (Table 6, Lines I-IV). As a result, the efficiency of the modifiers obtained is not as required.

TABLE 6

| | | Parameters in the | | | | | | | |
|---|---|---|---|---|---|---|---|---|---|
| | | Continuous | | | | | | | |
| | | Process of | | | Reducing | | | | |
| | No. of | Manufacturing | | | Effect of | | | | |
| | Reactors | | | Monomer | Water | | Compressive Strength | | |
| Sample | in | | | Conversion | Consumption | | Mortar Samples, N/mm² | | |
| No. | System | T, ° C. | pH | Amount, a % | % | W/C | 2 days | 7 days | 28 days |
| 1 | 2 | 3 | 4 | 5 | 6 | 7 | 8 | 9 | 10 |
| I | No. 1 | 28 | 11.8 | 12 | 17.6 | 0.412 | 44.6 | 61.3 | 68.5 |
| | No. 2 | 60 | 9.2 | 85 | | | | | |
| | No. 3 | 55 | 8.6 | 97 | | | | | |
| II | No. 1 | 50 | 8.8 | 28 | 16.4 | 0.418 | 42.0 | 58.4 | 61.9 |
| | No. 2 | 75 | 8.1 | 88 | | | | | |
| | No. 3 | 68 | 7.2 | 94 | | | | | |
| III | No. 1 | 40 | 10.9 | 19 | 17.0 | 0.415 | 45.2 | 63.0 | 66.7 |
| | No. 2 | 48 | 10.0 | 78 | | | | | |
| | No. 3 | 62 | 8.8 | 96 | | | | | |
| IV | No. 1 | 38 | 10.5 | 18 | 18.6 | 0.407 | 48.4 | 63.5 | 68.4 |
| | No. 2 | 82 | 8.0 | 91 | | | | | |
| | No. 3 | 66 | 7.3 | 98 | | | | | |
| V | No. 1 | 40 | 10.3 | 20 | 17.9 | 0.410 | 46.0 | 63.4 | 67.5 |
| | No. 2 | 74 | 9.2 | 88 | | | | | |
| | No. 3 | 45 | 9.0 | 96 | | | | | |
| VI | No. 1 | 37 | 10.4 | 18 | 21.5 | 0.393 | 47.3 | 64.0 | 69.5 |
| | No. 2 | 68 | 9.1 | 87 | | | | | |
| | No. 3 | 84 | 7.2 | 100 | | | | | |
| VII | No. 1 | 32 | 11.5 | 16 | 27.0 | 0.365 | 52.6 | 82.2 | 96.4 |
| | No. 2 | 78 | 8.2 | 98 | | | | | |
| | No. 3 | 58 | 8.1 | 100 | | | | | |
| VIII | No. 1 | 40 | 10.2 | 18 | 28.0 | 0.360 | 54.0 | 83.7 | 100.6 |
| | No. 2 | 65 | 9.7 | 97 | | | | | |
| | No. 3 | 60 | 8.8 | 100 | | | | | |
| IX | No. 1 | 48 | 9.0 | 20 | 27.0 | 0.365 | 53.0 | 84.3 | 98.7 |
| | No. 2 | 52 | 8.8 | 95 | | | | | |
| | No. 3 | 70 | 7.8 | 100 | | | | | |

Observations:

In all the tests shown in Table 6, 0.7% of the modifier was used (with respect to the cement mass). Cement Type I-O/45 A (Type 1) was used; the values of water to cement (W/C) were selected in such a manner that the slump in all cases was 170±5 mm.

If the temperature in the third reactor surpasses the optimum temperature (Table 6, Line VI) a monomer conversion of 100% is obtained, however, the product obtained has a low efficiency compared to the modifiers following the optimum processs of the synthesis (Table 6, Lines VII-IX).

### EXAMPLE 5

The preparation of the modifier for cement systems was carried out as in Example 2. Synthesis was achieved by use of the continuous process, supplying an optimum composition of the refrigerated monomer solution and initiating system to the first reactor of the series continuously at a temperature not higher than 33° C., and at a regulated speed. Each of the reactors had a jacket to provide water for refrigeration, a mixer, a thermometer and a pH meter. The transfer of the reactive mass from one reactor to another and the exit of the product from the last reactor were achieved by means of gravity through a device in the upper part of the reactor. As soon as the monomer conversion reached 100% and the reactive mass had been cooled to a temperature of 55-67° C. in the last reactor, the optimum amount of copolymer of formaldehyde with the polycondensed desulfitade was introduced into the reactor. At the same time the temperature was stabilized at 55-60° C. The specific production of the process was Q=2.5-3.0 kg per hour. The technological parameters of the synthesis and test results using the modifier in the mortar are shown in Table 7.

TABLE 7

| | | Parameters in Continuous | | | Reducing | | | | |
|---|---|---|---|---|---|---|---|---|---|
| | No. of | Processes of Manufacturing | | | Effect of | | | | |
| | Reactors | | | Monomer | Water | | Compressive Strength | | |
| Sample | in | | | Conversion | Consumption | | Mortar Samples, N/mm² | | |
| No. | System | T, ° C. | pH | Amount, a % | % | W/C | 2 days | 7 days | 28 days |
| 1 | 2 | 3 | 4 | 5 | 6 | 7 | 8 | 9 | 10 |
| I | No.1 | 42 | 10.9 | 12 | 18.7 | 0.410 | 42.3 | 57.6 | 64.2 |
| | No.2 | 60 | 8.6 | 89 | | | | | |
| | No.3 | 54 | 8.1 | 95 | | | | | |
| II | No.1 | 58 | 8.5 | 32 | 18.5 | 0.408 | 40.5 | 56.3 | 59.8 |
| | No.2 | 68 | 8.3 | 90 | | | | | |
| | No.3 | 50 | 7.9 | 97 | | | | | |
| III | No. 1 | 48 | 10.2 | 25 | 17.1 | 0.415 | 44.0 | 61.3 | 63.7 |
| | No. 2 | 50 | 9.3 | 85 | | | | | |
| | No. 3 | 52 | 8.5 | 95 | | | | | |
| IV | No. 1 | 50 | 9.9 | 27 | 18.9 | 0.406 | 45.6 | 62.4 | 64.8 |
| | No. 2 | 73 | 8.1 | 95 | | | | | |
| | No. 3 | 55 | 7.8 | 98 | | | | | |
| V | No. 1 | 50 | 9.8 | 28 | 19.8 | 0.401 | 46.3 | 59.8 | 65.7 |
| | No. 2 | 61 | 8.5 | 90 | | | | | |
| | No. 3 | 48 | 8.4 | 97 | | | | | |
| VI | No. 1 | 46 | 10.5 | 20 | 23.2 | 0.384 | 47.6 | 62.8 | 69.4 |
| | No. 2 | 78 | 8.7 | 95 | | | | | |
| | No. 3 | 60 | 7.7 | 100 | | | | | |
| VII | No. 1 | 45 | 10.5 | 21 | 26.8 | 0.366 | 51.9 | 80.7 | 97.6 |
| | No. 2 | 70 | 8.5 | 95 | | | | | |
| | No. 3 | 55 | 8.3 | 100 | | | | | |
| VIII | No. 1 | 48 | 10.1 | 25 | 27.4 | 0.363 | 55.0 | 84.3 | 101.8 |
| | No. 2 | 62 | 8.8 | 89 | | | | | |
| | No. 3 | 58 | 8.0 | 100 | | | | | |
| IX | No. 1 | 55 | 9.8 | 30 | 27.0 | 0.365 | 54.2 | 83.8 | 100.2 |
| | No. 2 | 63 | 8.2 | 92 | | | | | |
| | No. 3 | 65 | 7.8 | 100 | | | | | |

Observations:

As in Table 6, in all the tests shown in Table 7, the amount of modifier was 0.7% with respect to the cement mass Type I-O/45 A (Type 1); composition of the cement mortar: sand=1:3, with W/C values which assure the same consistency (170±5 mm) equal to the reference composition (Table 5, Line 9).

From the results shown in Table 7 it can be seen that when the optimum parameters are observed in the process, the required monomer conversion takes place in each reactor, (T=45-55° C. in the first reactor, 62-70° C. in the second and 55-65° C. in the third reactor; pH=9.8-10.5; 8.2-8.8 and 7.8-8.3 respectively). The final product is characterized by a high efficiency (Table 7, Lines VII-IX).

If in any of the reactors of the system the temperature is raised above the stated limit, it is impossible to regulate the pH of the reactive mass. Also, 100% monomer conversion is not obtained during the passing of the reactive mixtures through the system and consequently, the expected efficiency of the modifiers is not obtained (Table 7, Lines I-V). Even if a 100% of monomer conversion is achieved by increasing the temperature above the optimum value in the second reactor, the required modifier efficiency is not assured (Table 7, Line VI) as compared with the optimum parameters in the synthesis (Table 7, Lines VII-IX).

### EXAMPLE 6

The modifier for the cement systems was obtained as in Example 2. Synthesis was achieved by the continuous process in a system of two reactors of the same volume. Each of the reactors had a jacket to provide water for refrigeration, a mixer, a thermometer and a pH meter. The supply of the reagents in the first reactor of the system was made as in Examples 4 and 5. As soon as the monomer reached 100% conversion and the reactive mass was cooled to 60-67° C., the optimum quantity of copolymer of formaldehyde with polycondensed desulfitade was introduced. At the same time, the temperature of the reactive mass was stabilized at 55-63° C. The specific production of the process was Q=2.4-3.1 kg per hour.

The technological parameters of the synthesis and test results with the modifier for the cement systems are shown in Table 8.

TABLE 8

| | | Parameters in | | | | | | | |
|---|---|---|---|---|---|---|---|---|---|
| | | Continuous | | | Reducing | | | | |
| | Number | Processes of | | | Effect of | | Compressive | | |
| | of | Manufacturing | | | Water | | Strength | | |
| | Reactors | | | Monomer | Consump- | | Mortar Samples, | | |
| Sample | in | | | Conversion | tion | | N/mm² | | |
| No. | System | T, ° C. | pH | Amount, a % | % | W/C | 2 days | 7 days | 28 days |
| I | No. 1 | 43 | 10.2 | 43.0 | 26.5 | 0.368 | 52.2 | 79.6 | 96.8 |
| | No. 2 | 70 | 7.1 | 100 | | | | | |
| II | No. 1 | 52 | 9.5 | 46.5 | 27.85 | 0.361 | 56.0 | 82.1 | 100.4 |
| | No. 2 | 63 | 7.8 | 100 | | | | | |
| III | No. 1 | 60 | 8.7 | 60.0 | 27.0 | 0.365 | 54.8 | 80.5 | 98.7 |
| | No. 2 | 56 | 8.5 | 100 | | | | | |

Observations:

The test conditions of the modifier for cement systems were the same test conditions shown in Tables 6 and 7.

### EXAMPLE 7

The modifier for the cement systems was prepared as in Example 4. An aqueous solution of one or various hydroxides of earth-alkaline metals or the mixture with water of the corresponding oxides was used as the initiator of the system. Experiments established that the modifier obtained has the same efficiency as the modifiers shown in Example 4 (Table 6, Lines VII-IX).

### EXAMPLE 8

The modifier for the cement systems was prepared as in Example 3. A mixture of hydroxides of earth-alkaline metals with one or various salts of the generic formula M(Noₓ)_{y} where x=2 or 3 and y=1 or 2 was used as the alkaline initiator.

The compositions used for the initiating systems and the efficiency of the modifiers obtained are shown in Table 9.

As can be seen from the data in Table 9, utilizing the optimum combination of components of the initiating systems (Table 9, Lines 1-10) (proportion M(ON)₂: M(Noₓ)_{y}=1:1 and 1:1.5), independent of the anionic composition of the salts mixture, there is an acceleration of the polymerization process with a corresponding increase in the efficiency of the process. The modifiers obtained have a high efficiency in cement systems. If there is an increase in the salts content of the initiating system components (Table 9, Line 11), there is a reduction in the specific production of the modifier and a decrease in the plasticizing effect. The decreasing effect of water consumption is also worsened. If the quantity of salts is reduced in the composition of the initiating system, the plasticizing effect of the modifier remains the same and the specific production of the process proportionally diminishes with respect to the quantity of salts in the total mass of the inorganic components.

TABLE 9

| | | | |
|---|---|---|---|
| | | Mortar | |
| | | Slump, | |
| | | Standard | Reducing |
| | Producti | Cone | Effect of |
| Composition of Starting System, Mass | on | (Cement- | Water |

| | | | | | | | | |
|---|---|---|---|---|---|---|---|---|
| Sample | Quantities | Q, kg | Sand) | Consumption, | | | | |
| No. | M(ON)₂ | MNO₂ | MNO₃ | M(NO₂)₂ | M(NO₃)₂ | per hour | mm | % |

| | | | | | | | | |
|---|---|---|---|---|---|---|---|---|
| 1 | 40 | 60 | — | — | — | 1.70 | 298 | 26.8 |
| 2 | 40 | — | 60 | — | — | 1.72 | >300 | 27.7 |
| 3 | 40 | — | — | 60 | — | 1.65 | >300 | 27.0 |
| 4 | 50 | — | — | — | 50 | 1.42 | >300 | 27.2 |
| 5 | 40 | 30 | 30 | — | — | 1.72 | 297 | 26.6 |
| 6 | 40 | — | 30 | 30 | — | 1.75 | 300 | 27.0 |
| 7 | 50 | — | — | 25 | 25 | 1.50 | >300 | 27.5 |
| 8 | 40 | 15 | 15 | 15 | 15 | 1.80 | 296 | 26.9 |
| 9 | 40 | 30 | — | — | 30 | 1.65 | >300 | 27.8 |
| 10 | 50 | — | 25 | 25 | — | 1.50 | >300 | 28.0 |
| 11 | 20 | 40 | — | — | 40 | 0.75 | 226 | 19.6 |
| 12 | 100 | — | — | — | — | 1.00 | >300 | 27.3 |

Observations:

All the mixtures had the same material proportions (cement:sand:water=1:3:0.5=constant); the amount of modifier used was 0.7% (equivalent to dry modifier), with respect to the cement mass Type I-O/45 A (Type 1). Slump using the standard cone was 167 mm.

### EXAMPLE 9

The modifier for the cement systems was prepared as in Example 3. When the monomer conversion reached 100% and the optimum amount of copolymer of formaldehyde with polycondensed desulfitade was introduced, the molecular mass average of the modifiers obtained did not exceed 340 Dalton. Viscosity did not exceed 2×10⁻³ NC/m² and the concentration was 45.5%.

The synthesized modifiers were used in the grinding of portland clinker with calcium sulfate and different mineral additives under industrial conditions.

The characteristics of the modifiers obtained are shown in Table 10 and their influence on the dispersion of cements are shown in Table 12.

TABLE 10

| | | Principal Modifier Characteristics | | |
|---|---|---|---|---|
| Sample | Modifier | Conversion | Average Mol. | Viscosity, |
| No. | Type | Amount, % | Mass, Dalton | 10⁻³, N C/m³ |
| 1 | Disclosed | 100 | 310 | 1.78 |
| 2 | Disclosed | 100 | 289 | 1.73 |
| 3 | Disclosed | 100 | 340 | 2.00 |
| 4 | Prototype | 93 | 1945 | 9.40 |

From the results obtained in Table 11 it can be seen that with the use of the disclosed modifier in the grinding of clinker, calcium sulfate (Table 11, Lines 1-3) or clinker, calcium sulfate and various mineral additives (Table 11, Lines 4-6), the specific surface of the cement (as Blaine) is increased from 1100 to 1600 cm²/gr for cement with clinker alone (without mineral additives) and from 700 to 1000 cm²/gr for cement with different mineral additives without any change in mill production. At the same time, a correlation can be seen between the increase of the specific surface of the cements and the amount of modifier. The proportion of the modified cement particles with a diameter of up to 30 microns is also increased 10-17% in comparison with portland cement without modifier. The prototype modifier (Lines 11-14), in effect, does not modify the characteristics of the cements previously indicated.

Cements obtained industrially by grinding together clinker, gypsum with two water molecules, and modifier were used to prepare mortar and concrete samples. These samples were studied during standard hardening ages. These results are shown in Tables 12 and 13.

From Table 12 we can observe that cement produced by grinding together clinker, calcium sulfate and all the different quantities of modifier obtained by the disclosed process increases the compressive strength of standard mortar (cement:sand:water=1:3:0.5) an average of 17% at all standard ages of hardening of the samples (Lines 2, 4, and 6) in comparison with the reference samples (Table 12, Line 1).

Samples of modified cement having the same consistency as the control samples (Table 12, Lines 3, 5 and 7) show higher strength, which increases 42-55% at 2 days and 51-78% at 28 days of hardening as compared to the control samples.

The results are similar for concretes prepared with modified cements (See Table 13, Lines 2-7).

One of the variants of these experiments was the use of modified cements obtained by grinding together clinker (71.5%), calcium sulfate with two water molecules (3.5%), fly ash (25%) and the disclosed modifier (0.9% of dry modifier with respect to the clinker mass) for self-leveling mortar and concrete.

Mortar slump was determined using a hollow metal cylinder with an interior diameter of 80 mm and a height of 150 mm. The cylinder was placed on a horizontal glass surface and was filled with mortar without additional compaction (auto-compaction). The mortar was leveled at the top and the metal cylinder was raised slowly. At that moment, when the mortar slumped over the glass due to its own weight, the diameter of the slump was measured. Standard samples were made and were kept under normal curing conditions until compressive strength tests were performed at the required ages.

The displacement of the auto-leveling concrete samples was determined by the traditional process.

Results of these tests are shown in Tables 14 and 15.

TABLE 11

| | | | Cement Compositon, Mass Quantities | | | | | | | Particle |
|---|---|---|---|---|---|---|---|---|---|---|
| | | | | Gypsum | | | | | Specific | Quantities |
| | | Modifier | | with | | | | Mill | Surface, | to 30 |
| Sample | Modifier | Quantity | | 2 Mol. of | | Fly | Natural | Production | Blaine | Microns |
| No. | Type | % * | Clinker | Water | Slag | ash | Pozzolan | Ton/hour | cm²/gr | % |
| 1 | Disclosed | 0.5 | 95 | 5.0 | — | — | — | 14.0 | 5500 | 80.6 |
| 2 | Disclosed | 0.7 | 95 | 5.0 | — | — | — | 14.0 | 5900 | 84.5 |
| 3 | Disclosed | 0.9 | 95 | 5.0 | — | — | — | 14.0 | 6100 | 86.2 |
| 4 | Disclosed | 0.6 | 47.5 | 2.5 | 50 | — | — | 16.0 | 5400 | |
| 5 | Disclosed | 0.7 | 47.5 | 2.5 | — | 50 | — | 22.0 | 5500 | |
| 6 | Disclosed | 0.7 | 47.5 | 2.5 | — | — | 50 | 22.0 | 5600 | |
| 7 | — | — | 95 | 5.0 | — | — | — | 14.0 | 4400 | 71.1 |
| 8 | — | — | 47.5 | 2.5 | 50 | — | — | 16.0 | 4200 | |
| 9 | — | — | 47.5 | 2.5 | — | 50 | — | 22.0 | 4350 | |
| 10 | — | — | 47.5 | 2.5 | — | — | 50 | 22.0 | 4430 | |
| 11 | Prototype | 0.9 | 95 | 5.0 | — | — | — | 14.0 | 4600 | 72.3 |
| 12 | Prototype | 0.9 | 47.5 | 2.5 | 50 | — | — | 16.0 | 4350 | |
| 13 | Prototype | 0.9 | 47.5 | 2.5 | — | 50 | — | 22.0 | 4500 | |
| 14 | Prototype | 0.9 | 47.5 | 2.5 | — | — | 50 | 22.0 | 4560 | |

TABLE 12

| | | | | Mortar Slump, | Compressive | | |
|---|---|---|---|---|---|---|---|
| | | Modifier | | Standard Cone | Strength | | |
| Sample | Modifier | Quantity | | (cement-sand) | N/mm² | | |
| No. | Type | % | W/C | mm | 2 days | 7 days | 28 days |
| 1 | | | 0.50 | 152 | 36.4 | 46.5 | 54.8 |
| 2 | Disclosed | 0.5 | 0.50 | 276 | 42.5 | 53.2 | 64.0 |
| 3 | Disclosed | 0.5 | 0.40 | 150 | 51.8 | 77.4 | 82.6 |
| 4 | Disclosed | 0.7 | 0.50 | 290 | 41.3 | 52.6 | 65.2 |
| 5 | Disclosed | 0.7 | 0.38 | 152 | 56.4 | 80.5 | 92.7 |
| 6 | Disclosed | 0.9 | 0.50 | >300 | 43.4 | 52.0 | 63.8 |
| 7 | Disclosed | 0.9 | 0.37 | 165 | 55.9 | 83.4 | 97.5 |
| 8 | Prototype | 0.9 | 0.50 | 186 | 32.6 | 44.5 | 52.2 |
| 9 | Prototype | 0.9 | 0.38 | 148 | 47.8 | 66.7 | 71.3 |

TABLE 13

| | | Modifier | | Standard | Concrete | Compressive Strength | | |
|---|---|---|---|---|---|---|---|---|
| Sample | Modifier | Quantity | | Cone | Density | N/mm² | | |
| No. | Type | % | W/C | cm | kg/m³ | 2 days | 7 days | 28 days |
| 1 | | | 0.62 | 6.0 | 2386 | 22.9 | 31.0 | 36.4 |
| 2 | Disclosed | 0.5 | 0.62 | 22.0 | 2410 | 25.6 | 35.8 | 43.7 |
| 3 | Disclosed | 0.5 | 0.50 | 6.5 | 2480 | 34.0 | 46.2 | 58.0 |
| 4 | Disclosed | 0.7 | 0.62 | 2.0 | 2408 | 25.3 | 34.8 | 42.4 |
| 5 | Disclosed | 0.7 | 0.48 | 6.0 | 2495 | 36.0 | 47.3 | 59.7 |
| 6 | Disclosed | 0.9 | 0.62 | 27.0 | 2406 | 25.9 | 34.4 | 41.3 |
| 7 | Disclosed | 0.9 | 0.47 | 7.0 | 2512 | 36.8 | 48.9 | 60.6 |
| 8 | Prototype | 0.9 | 0.62 | 24.0 | 2362 | 21.0 | 29.7 | 35.1 |
| 9 | Prototype | 0.9 | 0.47 | 6.5 | 2430 | 29.6 | 39.4 | 45.5 |

Observations:

The mixtures used were cement:sand:gravel=1:2.77:3.5, using Type 1-O/45A (Type 1) cement—300 kg/m³. Cylindrical samples with a diameter of 15 cm and a height of 30 cm were tested.

TABLE 14

| | | Mortar Composition | | Water | Mortar | Compressive Strength | | |
|---|---|---|---|---|---|---|---|---|
| Sample | | Mass Quantities | | Cement + | Slump, | N/mm² | | |
| No. | Cement Type | Cement | Sand | Sand* | mm | 2 days | 7 days | 28 days |
| 1 | Traditional | 31 | 69 | 0.16 | 118 | 10.7 | 23.2 | 33.8 |
| | Cement | | | | | | | |
| | Type II-C/35A | | | | | | | |
| | (Type 11) | | | | | | | |
| 2 | Modified with | 31 | 69 | 0.16 | 236 | 14.2 | 36.4 | 48.6 |
| | Disclosed | | | | | | | |
| | Modifier | | | | | | | |
| 3 | As in 2 | 28 | 72 | 0.175 | 244 | 13.8 | 35.9 | 47.4 |
| 4 | As in 2 | 25 | 75 | 0.185 | 238 | 12.6 | 34.7 | 46.2 |
| 5 | Modified with | 31 | 69 | 0.16 | 230 | 9.8 | 22.0 | 31.2 |
| | Prototype | | | | | | | |
| | Modifier | | | | | | | |

*Standard construction sand size 0.14-5.0 mm was used for the tests.

As can be seen from the results in Table 14, using the same proportions of water/cement plus sand, mortars using cements with the disclosed modifier have very high auto-leveling properties; also, the compressive strength of the samples is much higher at all hardening ages (Table 14, Lines 2-4) compared to the compressive strength of the control sample (Line 1). The superior characteristics of the disclosed modifier are also evident in the composition of the modified cement when compared with modified cement containing the prototype modifier (Line 5). In all cases, mortar samples with the disclosed modified cement and which contain the disclosed modifier are more homogeneous and have a dense microstructure.

TABLE 15

| | | Concrete Composition, kg/m³ | | | | Standard | Concrete | Compressive Strength | | |
|---|---|---|---|---|---|---|---|---|---|---|
| Sample | Type of | | | Coarse | | Cone, | Density, | N/mm2 | | |
| No. | cement | Cement | Sand | Aggregate | Water | cm | kg/m³ | 2 days | 7 days | 28 days |
| 1 | Traditional | 320 | 813 | 1060 | 186 | 5.8 | 2345 | 23.2 | 30.8 | 37.6 |
| | Cement | | | | | | | | | |
| 2 | Cement | 320 | 813 | 1060 | 186 | 27 | 2372 | 28.6 | 38.4 | 49.5 |
| | Modified | | | | | | | | | |
| | with | | | | | | | | | |
| | Disclosed | | | | | | | | | |
| | Modifier | | | | | | | | | |
| 3 | Cement | 320 | 813 | 1060 | 186 | 24.8 | 2330 | 21.4 | 31.6 | 35.4 |
| | Modified | | | | | | | | | |
| | with | | | | | | | | | |
| | Prototype | | | | | | | | | |
| | Modifier | | | | | | | | | |

Observations:

Cement Type II-C/35 A (Type 11) was used, limestone sand size was 0.14-5.0 mm and limestone coarse aggregate size was from 5 to 25 mm.

From the tests, it is evident that there is no water segregation or heating of the mixture if the indicated concrete composition (Table 15, Line 2) based on cement modified with the disclosed modifier is used. It can be said that the concrete mixture slumps spontaneously to a magnitude of the maximum diameter of the coarse aggregate. As in the previous tests, concrete made with modified cement has a higher density and a high compressive strength (Table 15, Line 2) at all standard ages of hardening in comparison with the reference sample (Table 15, Line 1) and the sample made with modified cement using the prototype modifier.

In general, the examples shown above confirm the advantages of the disclosed modifier not only in the synthesis process but also in the improved technical properties of concrete systems when compared with known modifiers.

I claim:

1. A process of making a modifier for cement systems, said modifier being characterized by a high plasticizing effect;
reduction in the use of water; no retardation in the kinetics of hardening of cement systems;
an increase in the dispersion of cement in the mill for grinding the cement clinker; an increase in mill production while maintaining the desired clinker characteristics of the cement;
an increase in the density and strength of cement systems at all hardening ages;
said process comprising synthesis by polymerization in a soft alkaline catalysis for achieving a high level of production ranging from 0.25-3.0 kg per hour, without using external thermal energy, but utilizing the exothermic effect at the beginning of the initiating monomer cycle for starting a polymerizing reaction and temperature maintenance during the polymerization procedure; while also using an optimum quantity of copolymer of formaldehyde with polycondensed desulfitade introduced as a synergist at a reactive mass temperature of substantially 55-70° C. in order to increase the plasticizing effect, to reduce the water use and to regulate the molecular mass and homopolymer formation in the final phase of the synthesis.

2. A process according to claim 1, in which dioxilate of methylene calcium is dissolved in a solvent containing water and a dissolved aliphatic constituent selected from a group consisting of aliphatic aldehydes, aliphatic ketones, and a mixture of aliphatic aldehydes and ketones.

3. A process according to claim 2, in which the water and the dissolved constituents of the solvent are in substantially the following mass proportions:
Water 100
Addition of dissolved aliphatic constituents 1.0-100

4. A process according to claim 1, in which the process of making the modifier for cement systems is carried out as a periodic process in a reactor in a temperature range of 42-80° C., until the monomer has reached 100% conversion and the temperature of the reactive mass is 55-70° C., whereupon an optimum quantity of the synergist, a copolymer of formaldehyde with polycondensed desulfitade, is introduced into the reactor.

5. A process of making a modifier for cement systems, according to claim 2, in which the modifier is made in a continuous process in a system of 3 cascading reactors, each of the reactors having the same volume,
the method comprising the step of continuously and separately supplying the monomer solution and the initiating system in an optimum proportion to the first reactor,
the constituents being successively supplied to the second reactor and then to the third reactor;
as soon as the monomer has been 100% converted in the third reactor and the temperature of the reactive mass is 55-70° C., a calculated quantity of the synergist in the form of a copolymer of formaldehyde with polycondensed desulfitade being continuously added;
the first reactor acting as a homogenizer and initiator of the polymerization process;
the transfer of the reactive mass from one reactor to the next reactor and the exit of the final product being achieved by gravity;
the technological progress of the constituents being represented by the following table in which the percentage of the monomer conversion and polymerization being represented by “a”:

| | Reactor 1 | Reactor 2 | Reactor 3 |
|---|---|---|---|
| a, % | up to 20 | between 85-98 | 100 |
| T, ° C. | between 32-48 | 52-78 | 50-70 |
| pH | 9.0-11.5 | 8.2-9.7 | 7.6-8.8 |

6. A process of making a modifier for cement systems, according to claim 2, in which the modifier is made in a continuous process in a system of two cascading reactors, each of the reactors having the same volume,
the method comprising the steps of continuously and separately supplying the monomer solution. and the initiating system in an optimum proportion to the first reactor,
the constituents being supplied from the first reactor to the second reactor, a calculated quantity of the synergist in the form of a copolymer of formaldehyde with polycondensed desulfitade being continuously added to the second reactor;
the technological regime of the constituents being represented by the following table in which the percentage of the monomer conversion and polymerization being represented by “a”:

| | Reactor 1 | Reactor 2 |
|---|---|---|
| a, % | up to 60 | 100 |
| T, ° C. | between 43-60 | 52-70 |
| pH | 8.7-10.2 | 7.1-8.5 |

As soon as the monomer has reached 100% conversion and the temperature of the reactive mass is not less than 52° C., an optimum quantity of a synergist in the form of copolymer of formaldehyde with polycondensed desulfitade is added to the second reactor.

7. A process of making a modifier for cement systems according to claim 2, characterized in that in the polymerization process, an aqueous solution of at least one alkaline metal hydroxide is employed as an initiating system.

8. A process of making a modifier for cement systems according to claim 2, in which a mixture of hydroxides of alkaline-earth metals with at lease one salt of the generic formula M(NOₓ)_{y}, wherein x is selected from a group consisting of 2 and 3 while y is selected from a group consisting of 1 and 2, said mixture being used as an alkaline starter.

9. A process used of making a modifier for cement systems according to claim 2, in which when the polymerization process reaches 100% monomer conversion and the temperature of the reactive mass is not lest than 50° C., an optimum quantity of a synergist is introduced in the form of a copolymer of formaldehyde with polycondensed desulfitade, the molecular mass of the polymer formed is then distributed in the last phase as follows:
a light fraction with a molecular mass (MM) less than 120 Dalton, no more than 20 parts of the mass;
a medium fraction with MM of 150±50 Dalton, no more than 40 parts of the mass;
a heavy fraction with MM 180 Dalton, the remaining parts of the mass;
the average molecular mass of the final product being substantially 340 Dalton and the viscosity does not exceed 2×10⁻³ N×C/m².
